(19) United States
(12) Patent Application Publication
(10) Pub. No.: US 2009/0228875 A1
(43) Pub. Date: Sep. 10, 2009

(54) Method and System for Reducing Disk Allocation by Profiling Symbol Usage

(76) Inventor: Alex DeVries, Ottawa (CA)

Correspondence Address: FAY KAPLUN & MARCIN, LLP, 150 BROADWAY, SUITE 702, NEW YORK, NY, 10038, US

(21) Appl. No.: 12/041,981

(22) Filed: Mar. 4, 2008

(51) Int. Cl. G06F 9/45

(52) U.S. Cl. 717/154

(57) ABSTRACT

A system and method for executing an application, identifying a plurality of memory access operations performed by the application, logging a file and a memory address range within the file corresponding to the plurality of memory access operations and removing, from the file, a symbol that is not within the memory address range.

### BACKGROUND

Embedded computing devices store program code in flash memory or other types of memory. This code may include compiled runtimes such as Linux runtimes. Reducing the footprint of these runtimes may allow the device manufacturers to reduce device memory requirements, thereby reducing device costs.

Prior efforts have been made to reduce the footprint of runtime code by removing files, but many such efforts are configuration based. This means that a software developer must know what features of the runtime are required and have a detailed understanding of what files correspond to those required features. Such reduction may then only be done at the granularity level of individual files.

Another approach to reducing the size of runtime code scans a created root file system and finds all unused symbols in certain shared libraries. This approach may decrease the size of the runtime, but has two main drawbacks. First, any symbol referenced in any binary on the root file system will be retained, even if the parent symbols are never called. Second, because of the recompilation approach, only some libraries may be optimized using this approach.

### SUMMARY OF THE INVENTION

A method for executing an application, identifying a plurality of memory access operations performed by the application, logging a file and a memory address range within the file corresponding to the plurality of memory access operations and removing, from the file, a symbol that is not within the memory address range.

A system having a first device executing an application and logging a plurality of memory access operations performed by the application and a second device recording a file and a memory address range within the file corresponding to the plurality of memory access operations and removing, from the file, a symbol that is not within the memory address range.

A system having an analyzer receiving a profile log including a file identifier and a memory address range within the file corresponding to a plurality of memory access operations performed while executing an application, the analyzer further receiving a root file system for the application, the analyzer determining, based on the file identifier and the memory address range, a symbol that has not been accessed when the application is executed and a stripper removing the symbol from the file corresponding to the file identifier.

### BRIEF DESCRIPTION OF THE DRAWINGS

FIG. 1 shows an exemplary system for minimizing the footprint of code according to the present invention.

FIG. 2 shows an exemplary method for minimizing the footprint of code according to the present invention.

FIG. 3 shows an exemplary memory storing code to be minimized by the exemplary embodiments of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe methods and systems for minimizing the memory footprint of runtime code. In the exemplary embodiments, unused symbol references are removed from runtime files during the application development process to reduce the size of the runtime files that may eventually be implemented on the device.

Many embedded computing devices store runtime code on flash memory, which may be durable and compact, making it ideal for use on mobile embedded computing devices. However, flash memory may also be more expensive than other types of memory; thus, devices developers may wish to minimize the size of runtime code to be stored on embedded flash memory. The same principles may also be applied to minimizing the size of other types of code. In addition, while the exemplary embodiments are described with reference to flash memory, the present invention may be used with other types of persistent memory such as hard disks, etc.

The exemplary embodiments of the present invention describe systems and methods for reducing the size of runtime code that avoid the above described drawbacks. This disclosure makes specific reference to code that is being developed for use in embedded computing devices, code that is written for systems running Linux, and code that will be stored on flash memory. However, those of skill in the art will understand that the broader principles of the present invention are equally applicable to reducing the footprint of code that is being developed for any other operating system, type of device, or storage medium.

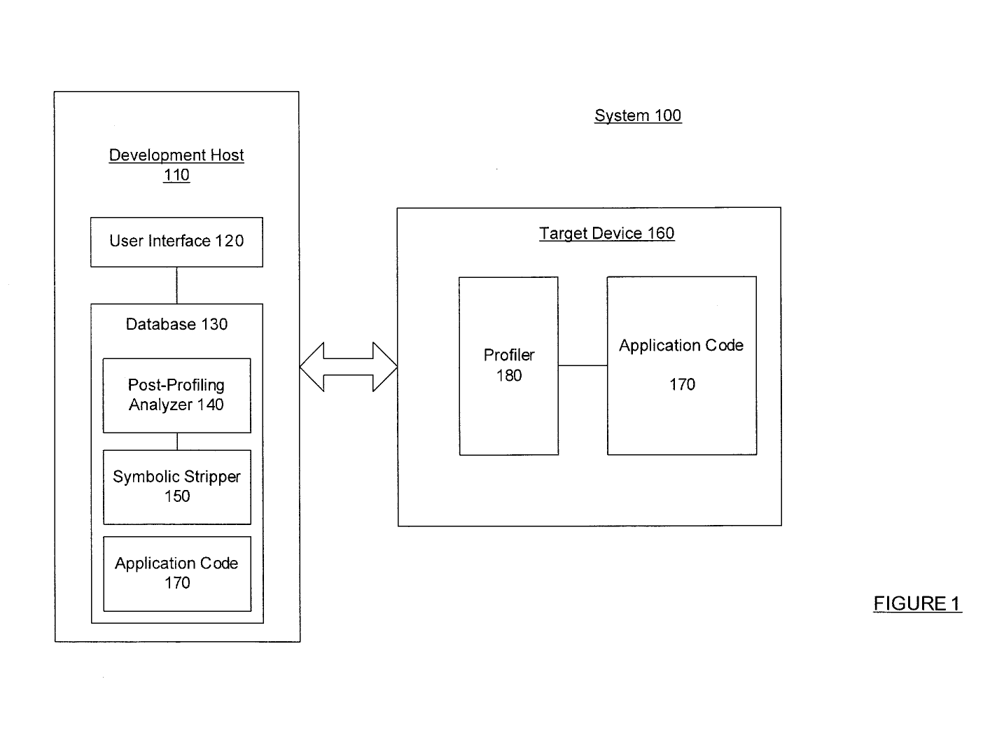

FIG. 1 illustrates an exemplary system 100 for implementing the present invention. The system 100 may include a development host 110 and a target device 160. The host 110 and the target device 160 may include conventional computing components such as a processor (e.g., a microprocessor, an embedded controller, etc.) and a memory (e.g., Random Access Memory, Read-only Memory, a hard disk, etc.). Communication between the host 110 and the target device 160 occurs over a communication link, which may be a wired (e.g., Ethernet, serial port, Universal Serial Bus, etc.) or wireless (e.g., Bluetooth, IEEE 802.1x, etc.) connection. It should be noted that while FIG. 1 illustrates an exemplary system including one target device 160, in other exemplary embodiments the host 110 may be in communication with two or more target devices.

The host 110 may include a user interface 120 and a database 130. The database 130 may include a post-profiling analyzer 140 and a symbolic stripper 150. Through the user interface 120, a user (e.g., a software developer) may control the operation of, and the transfer of data between, the host 110 and the target device 160.

The target device 160 may include compiled application code 170 (e.g., code for an application that is being developed to operate on the target device). The compiled application code 170 may initially be written in any programming language (e.g., C/C++, Assembly language, etc.) and may include source, header, library, object, and other data files. The target device may also include a profiler 180 for monitoring the execution of the application code 170, as will be described below with reference to the exemplary method 200. The database 130 of the development host 110 may also store a copy of the application code 170.

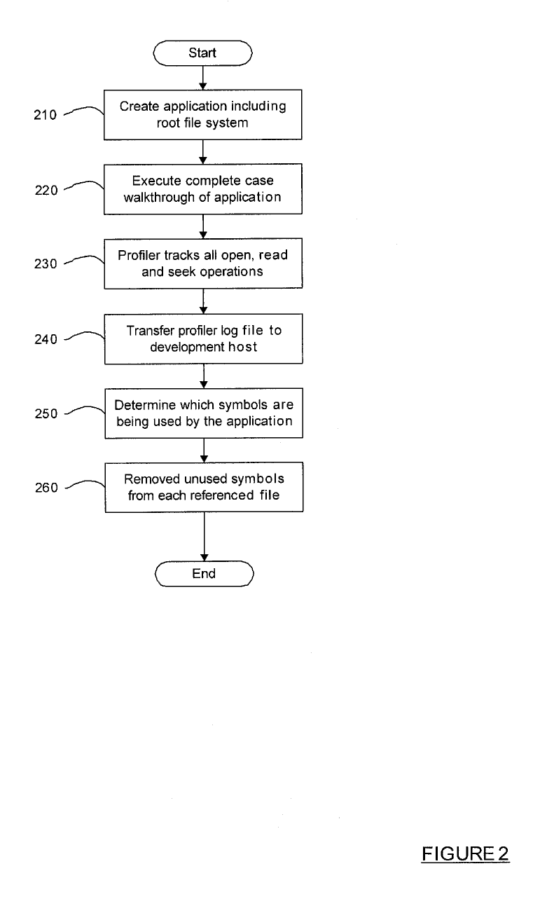

FIG. 2 illustrates an exemplary method 200 according to the present invention. The method 200 will be described with reference to the system 100 of FIG. 1. In step 210, a developer creates an application including a root file system that includes a superset of the required software components. The application may be developed for any purpose and for use in any computing environment, such as for use in an embedded computing device (e.g., the target device 160). The application may be, for example, the application code 170 as installed on the target device 160.

In step 220, a complete case walkthrough of the application code 170 is executed by the target device 160, while the profiler 180 monitors the execution process. This means that the application itself is executed multiple times to find “corner cases” (e.g., cases that are outside of normal operation) by using a broad variety of possible input parameters. This allows the profiler 180 to monitor system calls to all possible symbols that the application code 170 may require once it is implemented. Most notably, the profiler 180 may trap all open( ), read( ) and seek( ) system calls made during the execution of the application code 170.

The profiler 180 may achieve this monitoring process in a number of ways. If the root file system is mounted over a network file system (“NFS”), the network traffic may be tapped. Alternately, system calls may be recorded in user space by using, for example, the Linux command LD_PRELOAD (or a similar command in the operating system being used) to override the open( ), read( ) and seek( ) system calls. For example, the LD_PRELOAD environment that allows dynamically linked symbols of an executable to be re-vectored to a custom code. In such a situation, the open( ) function may be overloaded to point to an intermediary implementation that may log the file opening and then call the real open( ) . Additionally, system calls may be recorded by using the Linux tracing agent “strace” (or again, a similar utility in the operating system being used). In another example, a kernel-based profiling mechanism such as the Linux based profiler “oprofile” may also achieve this same result.

In step 230, the profiler 180 creates a profile log file of the execution of the application code 170 in step 220. The profile log file may include the identities of all files that were opened during the execution step 220, as well as the byte ranges that were read from each of the files that were opened. In step 240, the profile log file is transferred from the profiler 180 of the target device 160 to the post-profiling analyzer 140 of the development host 110.

In step 250, the analyzer 140 reads the profile log file, and further takes as input a list of all files on the runtime that was profiled and the symbol tables of all binaries and shared objects on the runtime. The symbol tables may match symbol names to offset locations (i.e., the physical location of symbols in memory). After receiving these inputs, the analyzer 140 may map the symbols that have been used and determine which symbols from which files may be removed.

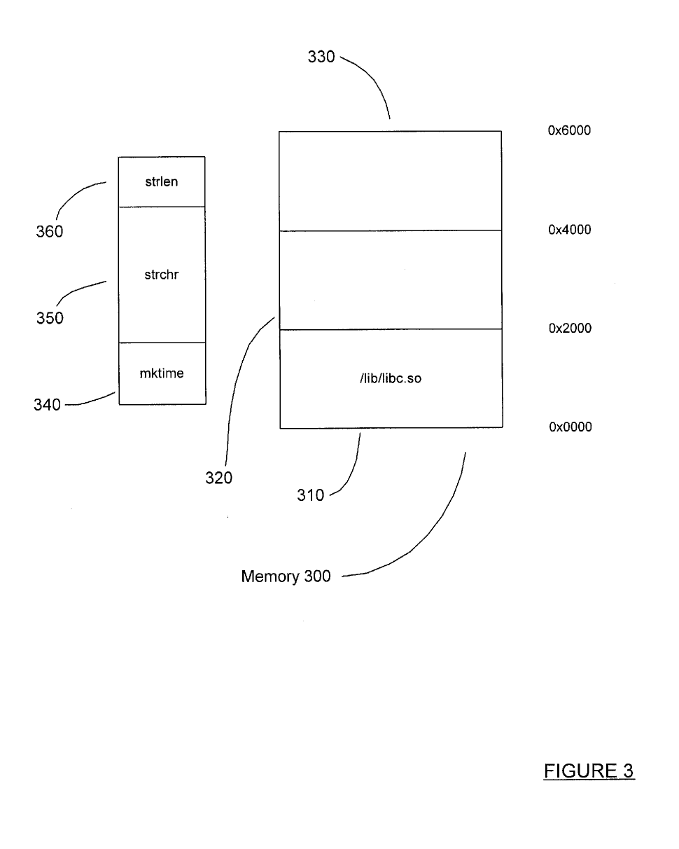

FIG. 3 illustrates an exemplary symbol table showing the offset locations of symbol names in an exemplary memory 300. The memory 300 contains a file designated as “/lib/libc.so” and may be subdivided into three blocks 310, 320 and 330. The block 310 begins at memory page 0x0000; the block 320 begins at memory page 0x2000; the block 330 begins at memory page 0x4000. The memory 300 may store symbol “mktime” 340 in a memory location within block 310. The memory 300 may further store symbol “strchr” 350 in memory locations that overlap blocks 310, 320 and 330. The memory 300 may further store symbol “strlen” 360 in memory locations within block 330.

For this example, assume the profiler recorded three system calls. The first may be an open( ) operation for the file “/lib/libc.so”. The second may be a seek( ) operation for the strchr symbol 350. The third may be a read( ) operation for a memory page within the range between pages 0x2000 and 0x4000. In this situation, only the memory pages 0x2000 to 0x4000 are referenced. By looking at the symbol map of the file /lib/libc.so as stored in the memory 300, the analyzer 140 may determine that the address range (i.e., corresponding to block 320) overlaps only the symbol strchr 350. The remaining symbols, mktime 340 and strlen 360, are never used.

Thus, returning to method 200, in step 260, the symbolic stripper 150 may remove unused symbols. To do this, the symbolic stripper 150 inspects the log generated by the profiler 180 in step 230 and the results of the analysis conducted by the analyzer 140 in step 250. The stripper copies each file (e.g., the file “/lib/libc.so”, etc.) and removes all symbols that were not used (e.g., in the example discussed with reference to step 250, the symbols mktime 340 and strlen 360). The output generated by the symbolic stripper 150 is a modified version of the application code 170 that only contains symbols that are required by the application.

By the implementation of the above described exemplary embodiments, the size of the application code 170 may be minimized. Minimizing the application code in turn reduces the required size of the storage space required to store the application code 170 on the target device 160 or other similar devices. Because flash memory, as may be used on many embedded computing devices, may be costly, such minimization is a desirable goal. Further, the above results may be achieved without any loss of functionality because only symbols that are unused are removed from the application code 170.

Those skilled in the art will understand that the above described exemplary embodiments may be implemented in any number of manners, including as a separate software module, as a combination of hardware and software, etc. For example, the method 200 may be a program containing lines of code that, when compiled, may be executed by a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A method, comprising:
executing an application;
identifying a plurality of memory access operations performed by the application;
logging a file and a memory address range within the file corresponding to the plurality of memory access operations; and
removing, from the file, a symbol that is not within the memory address range.

2. The method of claim 1, wherein the application is stored on a flash memory.

3. The method of claim 1, wherein the memory access operations are one of read operations, seek operations and open operations.

4. The method of claim 1, wherein the identifying includes one of tapping a network traffic, overriding the operation system calls, tracing the operation system calls and profiling the operation system calls.

5. The method of claim 1, further comprising:
generating a modified file corresponding to the file after the symbol has been removed.

6. The method of claim 1, wherein a plurality of files are logged.

7. The method of claim 6, wherein a plurality of memory address ranges for each of the plurality of files are logged.

8. The method of claim 6, wherein a plurality of symbols are removed from each of the plurality of files.

9. The method of claim 1, wherein the application is executed by a first device and the symbol is removed by a second device.

10. The method of claim 9, wherein the first device is a target device and the second device is a development host.

11. A system, comprising:
a first device executing an application and logging a plurality of memory access operations performed by the application; and
a second device recording a file and a memory address range within the file corresponding to the plurality of memory access operations and removing, from the file, a symbol that is not within the memory address range.

12. The system of claim 11, wherein the application is stored on a flash memory of the first device.

13. The system of claim 11, wherein the memory access operations are one of read operations, seek operations and open operations.

15. The system of claim 11, wherein the second device generates a modified file corresponding to the file after the symbol has been removed.

16. The system of claim 11, wherein the first device is a target device and the second device is a development host.

17. A system, comprising:
an analyzer receiving a profile log including a file identifier and a memory address range within the file corresponding to a plurality of memory access operations performed while executing an application, the analyzer further receiving a root file system for the application, the analyzer determining, based on the file identifier and the memory address range, a symbol that has not been accessed when the application is executed; and
a stripper removing the symbol from the file corresponding to the file identifier.

18. The system of claim 17, wherein the stripper further generates an updated file corresponding to the file after the symbol has been removed.

19. The system of claim 18, wherein the root file system is updated with the updated file.

20. A computer readable storage medium storing a set of instructions executable by a processor, the set of instructions operable to:
execute an application;
identify a plurality of memory access operations performed by the application;
log a file and a memory address range within the file corresponding to the plurality of memory access operations; and
remove, from the file, a symbol that is not within the memory address range.
